(19) United States
(12) Patent Application Publication
(10) Pub. No.: US 2008/0108037 A1
(43) Pub. Date: May 8, 2008

(54) Control of audience response systems during use with paper-based questions

(76) Inventor: Darin Beamish, Puyallup, WA (US)

Correspondence Address: DWC LAW FIRM, P.S., P.O. BOX 3041, SEATTLE, WA, 98114-3041, US

(21) Appl. No.: 11/584,346

(22) Filed: Oct. 19, 2006

(51) Int. Cl. G09B 3/00

(52) U.S. Cl. 434/350

(57) ABSTRACT

Methods and systems for controlling portable units in an audience response system when the audience response system is used for retrieving responses to paper-based questions. Some embodiments of the present invention comprise controlling the portable units to be capable of only displaying question indicia and user interface settings associated with assigned questions from paper-based documents, thereby excluding the display of other question indicia associated with non-assigned questions. Graphical user interfaces are also provided for selecting subsets of the questions from the paper-based questions for use in controlling the portable units.

### BACKGROUND OF THE INVENTION

1. Field of the Invention

The present invention relates to audience response systems for use in audience participation, and more particularly, to the control of user interface settings on portable units of the audience response system and graphical user interfaces therefor.

2. Description of Related Art

Audience response systems (or audience participation systems) typically include a host unit or base unit and a plurality of remotes, with the host unit coupled to a personal computer. A wired or wireless communication link is provided between the host unit and the remotes to allow audience members to transmit information using the remotes to the host unit, which in turn communicates with the personal computer through a communications link. The remotes can be handheld keypad devices having dedicated digital displays.

Audience response systems are often used in connection with paper-based documents. For example, in educational settings, teachers use the audience response systems to collect student responses to questions in text books or other paper-based questions. As a student reviews printed questions on a paper-based document, the student can use a remote to transmit a response to a particular question by (i) selecting a question number to be displayed on a dedicated display device of the remote, (ii) selecting an answer to a corresponding question printed on the paper-based document, using a keypad on the remote, and (iii) transmitting the answer to the host unit. The transmission will include information encoding the answer and associated question number, which can be used by a processor receiving the transmission for comparing the student's responses against an answer key. In such cases, although answer key data may have been stored in a digital file for grading the electronically received responses, the corresponding paper-based questions themselves may not have been stored electronically, so students still need to read the questions from a paper-based document (e.g., in their text books) before using the remotes to send their answers.

As is a common practice among educators, it is often desirable to only assign a portion of the questions on a paper-based document for students to answer for a given particular assignment, quiz, or test, such as, for example, certain questions “hand picked” by a teacher from a larger question-set provided in a chapter of text book. In such cases, a student using a remote to answer the “hand-picked” questionswhile reading them from a paper-based document must typically scroll through question numbers on the digital display device of the remote, or otherwise enter a question number using a keypad of the remote, in order to skip over multiple question numbers associated with non-assigned questions. This can often be inconvenient, and time consuming, and can increase the likelihood of error by transmitting an answer associated with a wrong question number.

Unlike paper-based answer sheets, where students can continuously see the entirety of their answers written out on paper, dedicated display devices for handheld remotes are typically small, in order to keep the remotes compact, and so cannot be used to display all of the students responses to questions for a particular question-set. This limits the amount of information students can see at any one time related to the responses they have provided. This can also increase the likelihood for error in providing a response to a non-assigned question because it is time consuming for a student to check each answer he or she has provided by scrolling one-by-one through different questions on the compact display of the remote. It is desirable to provide a method and system for overcoming these difficulties in an efficient manner.

### BRIEF SUMMARY OF THE INVENTION

Various embodiments of the present invention involve methods for instructing portable units (or “remotes”) with dedicated display devices to operate in accordance with modified question-sets. The portable units can be used to transmit responses to all questions in a master question-set provided on a paper-based document; however, when only a subset of the paper-based questions is assigned, the portable unit can be instructed to only allow user interface settings associated with the subset of questions to be displayed on the display devices. This can include allowing the portable units to only display question indicia associated with the assigned questions. Users can scroll through question indicia (e.g., question numbers) for assigned questions on their remotes, and read the corresponding questions from a paper-based document containing the master question-set, and use the portable units to respond to the assigned questions.

Various embodiments of graphical user interfaces are also provided to allow a user to conveniently configure the modified question-sets, and to save, load, and modify the modified question-sets.

Software products and computer implemented embodiments of the present invention are also presented herein.

### BRIEF DESCRIPTION OF SEVERAL VIEWS OF THE DRAWINGS

FIG. 1 is a diagram showing major components of an embodiment of an audience response system of the present invention.

FIG. 2 is a plan view of an embodiment of a portable unit for use with some embodiments of the present invention.

FIG. 3 is a simplified block diagram of an embodiment of the portable unit of FIG. 2.

FIG. 4 is a simplified block diagram for a computer, such as a PC, usable with some embodiments of the present invention.

FIGS. 5-8 illustrate examples of user interface settings displayable on the display device of the portable unit of FIG. 2.

FIG. 9 shows an embodiment of a setup screen of a graphical user interface for some embodiments of the present invention.

FIG. 10 is a diagram illustrating a portable unit operating in accordance with a modified question-set for some embodiments of the present invention.

FIG. 11 is a flow diagram for an embodiment of the present invention for playing a game using a paper-based question set.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available hardware, software and wireless systems associated with audience response systems have not been described in detail to avoid unnecessarily obscuring the descriptions of the embodiments of the invention.

Various embodiments of the present invention are described for illustration 5 purposes, in the context of a radio frequency (RF) communications link. However, as those skilled in the art will appreciate upon reviewing this disclosure, other methods of wireless communication may be suitable, such as, for example, infrared (IR). Also, various embodiments of the present invention are described in the context of students providing responses to paper-based questions. Those skilled in the art will appreciate that the same or substantially similar methods, systems, graphical user interfaces, and computer readable media can be used in a variety of audience settings without deviating from the spirit of the invention.

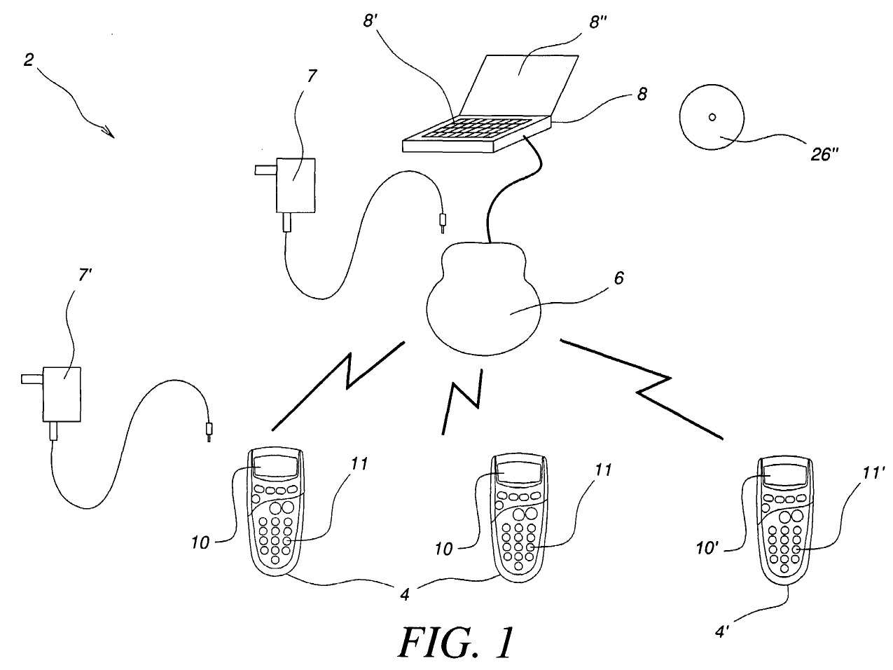

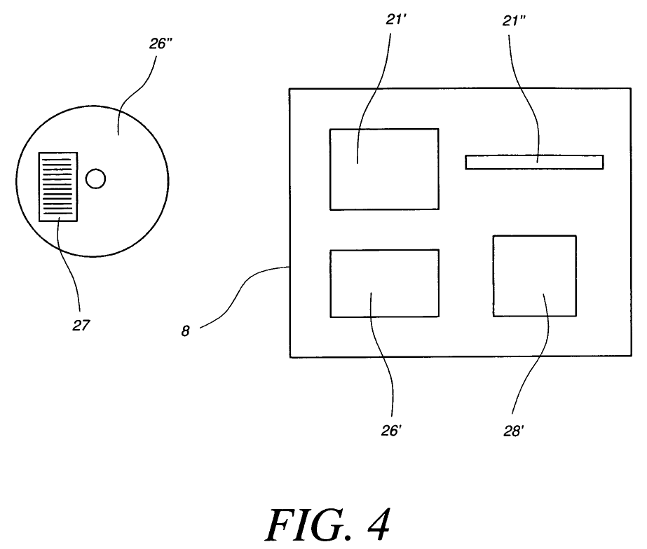

In some embodiments of the present invention an audience response system 2 is provided, having one or more portable units 4 and a host unit 6, as can be seen in FIG. 1. The portable units 4 can include a presenter unit 4′. The presenter unit 4′ may be pre-associated to have certain access rights to functions of the audience response system 2 not accessible to users of the other portable units 4, as will be appreciated by those skilled in the art after reviewing this disclosure. The host unit 6 may be communicatively connected to a computer 8, including, for example, a laptop or desktop PC, normally having a keyboard 8′, mouse or pointer (not shown) and monitor or display device 8″. Referring to FIG. 4, the computer 8 can also include a CPU or processor 21′, hard drive 26′ or other non-volatile memory, and a device 21″ for reading instructions or data from a computer readable medium 26″, such as, for example, but not limited to, floppy disks, digital compact discs, tapes, flash memory, etc. Various applications usable with the audience response system 2 can be executed using the computer 8.

A wireless communication link can be provided between the portable units 4 and the host unit 6 using infrared or radio frequency methods, structures, systems and related communication protocols, as will be appreciated by those skilled in the art after reviewing the present disclosure. For example, in some embodiments, wireless infrared communication is employed between the portable units 4 and host unit 6 using a polling method to avoid signal collisions, while in other embodiments, wireless radio frequency (RF) communication is employed, such as, for example, without limitation, by use of an IEEE 802.15.4 compliant communications link.

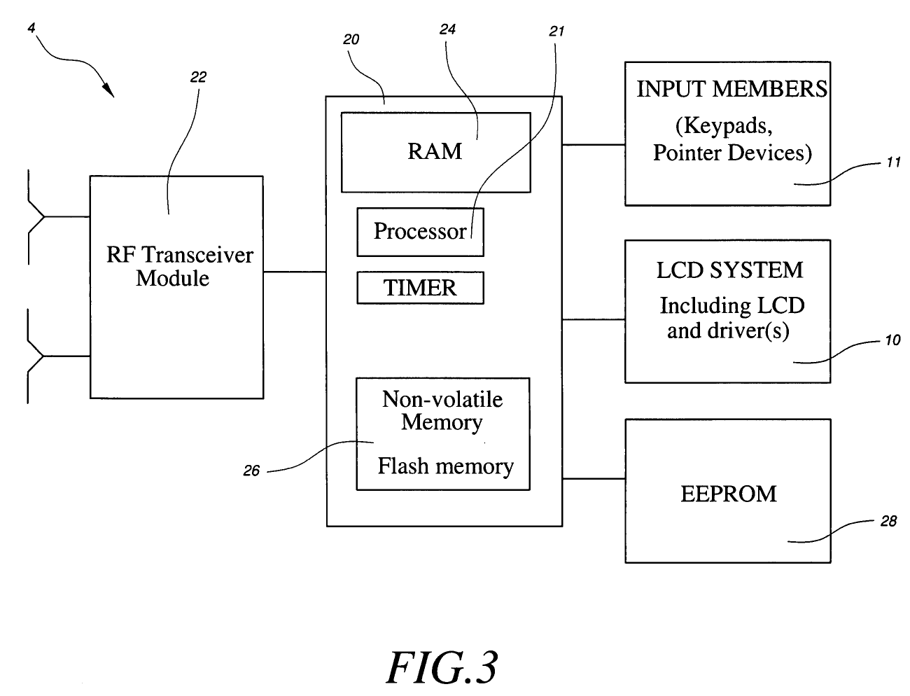

Various embodiments of the portable units 4 can be provided including that illustrated as a simplified block diagram in FIG. 3, which can comprise a display (LCD) system 10 (such as a liquid crystal display system with driver), input members 11 (e.g., manually operable input members such as, for example, keys, buttons, switches and pointers), an RF transceiver unit or module 22 and a microcontroller 20 having a processor 21, along with integral or peripheral RAM 24, writable non-volatile memory 26, such as flash memory, and programmable read only memory, such as, for example, EEPROM 28.

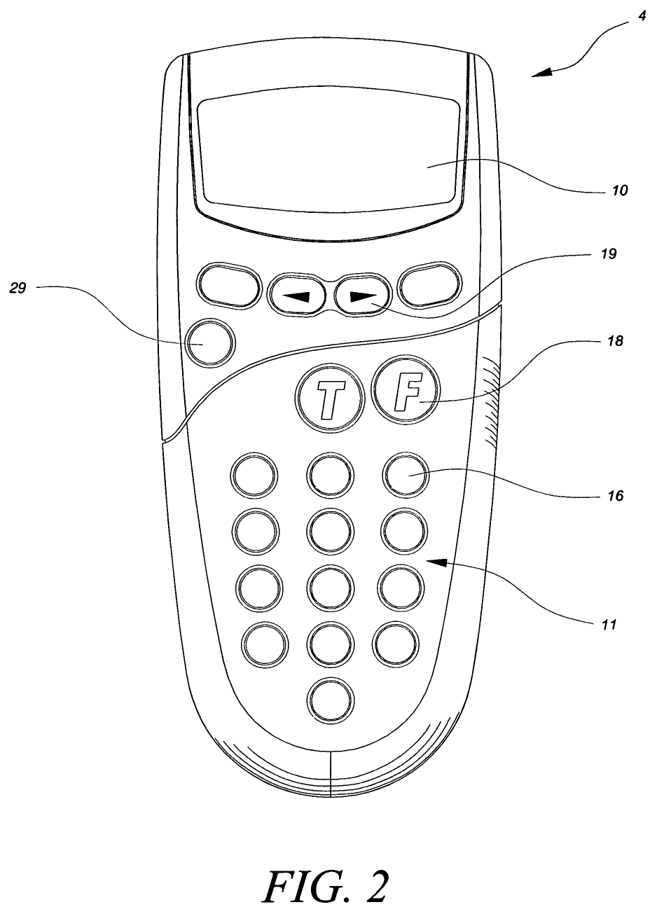

Referring to FIG. 2, some embodiments of the portable unit 4 have various manually operable input members 11, which can include scroll keys 19 and an alphanumeric keypad 16. Some input members 11 can be multifunctional, and configured to be operable in different modes, as will be appreciated by those skilled in the art after reviewing this disclosure. Designated keys 18 can be signified by one or more types of permanent markings on the keys or a surface of the portable unit 4, such as, for example, “YES” or “NO,” or “T” or “F” (signifying “TRUE” or “FALSE” in some embodiments) markings to simplify action required by a user to input responses to certain types of inquiries. Other designated keys can also be provided to simplify initiation of functions, such as, for example, a designated key for initiating a wireless transmission.

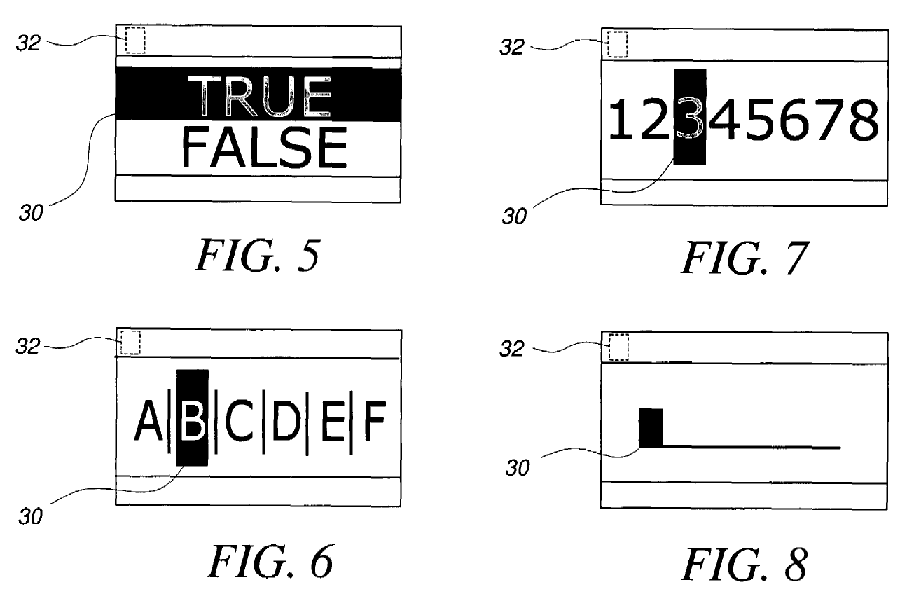

The scroll keys 19 can be used to navigate or make selections in user interfaces settings provided on the display device 10. For example, the display device 10 can display the user interface settings in FIGS. 5-8, with each setting comprising a cursor 30 that is moveable using the scroll keys 19. The cursor 30 can be moved to select or enter answer choices such as “TRUE” or “FALSE” in FIG. 5, any of the letters in FIG. 6, any of the numbers in FIG. 7, or any location in the data entry field in FIG. 8. Each of the selectable choices can represent responses to questions (or inquiries) that are provided to, or posed to, audience members. Also, the alphanumeric keypad 16 can be used to select answer choices or to type in answers on the display device 10.

Referring to FIG. 4, in some embodiments, one or more application programs 27 can be executed by the computer 8 to, among other things, display, evaluate and analyze responses to inquiries transmitted to the host unit 6 from audience members using the portable units 4. The application program can be provided on a computer readable medium 26″ such as, without limitation, floppy disks, CD-ROM disks, tapes, flash memory, system memory, DVD-ROM, or hard drives. The application program 27 can also provide a graphical user interface (GUI) on the computer 8 for use by presenter or teacher to implement and configure various activities, including, without limitation, to generate presentations for display to an audience that include inquiries, surveys, games, educational lessons and quizzes, etc, as will be described in further detail herein. As will be appreciated by those skilled in the art upon reviewing this disclosure, the possible variations for such activities are numerous.

In some embodiments of the present invention, the audience response system 2 is used in a teaching environment, such as a classroom or other instructional or educational setting. In such environments, students are often provided paper-based question-sets. The questions sets can be, for example, questions that are provided at the end of each chapter in a text book, or a paper-based test or quiz for grading or assessment purposes. In various embodiments of the present invention, digital answer keys files, corresponding to the paper-based question-sets, can be provided in compatible data file format for use with an application program 27, and stored on a memory device of computer 8. In such embodiments, students can utilize the portable units 4 to respond to the questions in the paper based question-sets, with their answers being transmitted to host unit 6 for analysis and grading using application program 27, as will be appreciated by those skilled in the art upon review of this disclosure.

For each paper-based question-set, a particular combination of user interface settings can be displayed on the display device 10 of the portable units. For example, any given question-set can comprise a combination of different answer formats (e.g., multiple-choice, true or false, or open response), with different associated possible answers. Thus, as shown in FIGS. 5-8, different user interface settings are provided for different answer formats. However, it can be desirable to pre-associate a user interface setting with each question in a question-set. Therefore, in some embodiments of the present invention, when a student uses the portable unit 4, an appropriate user interface setting is automatically displayed on the display device 10 of the portable unit 4 for each particular question the student selects to work on. This can be done by, for example, transmitting instructions to the portable units 4 that allow the portable units to associate any particular selected question number with a particular user interface setting.

In order to identify what sequence of user interface settings a portable unit 4 should use for a particular question-set, a question-set identifier (which can be, for example, a numerical code) can be provided to computer 8. For example, a student can be provided with a paper-based question-set, and a question-set identifier unique to the particular question-set, can be provided for the student to input into the portable unit 4 using keypad 11 when working on the question-set. The question-set identifier is then transmitted to the host unit 6, and computer 8. Also, the teacher can use the computer 8 to enter a question-set identifier that is used to control the sequence of interface settings of the portable units 4.

It is also noted that in some embodiments of the present invention, the application program 27 provides the option of allowing control of all or any one or more of a plurality of portable units 4 on a network using any particular question-set identifier. In this way, all portable units can be used to work on the same question-set, or different portable units can be used to work on different question-sets simultaneously.

Often, it is desirable for teachers to require students to answer only a portion of a particular paper-based question-set. For example, teachers often assign only odd or even questions from a particular question-set in a text book, sometimes with certain questions skipped in between others. In such cases, students utilizing the portable unit 4 may need to scroll through the question numbers 32, displayed on the portable units 4 in order to skip certain questions not assigned.

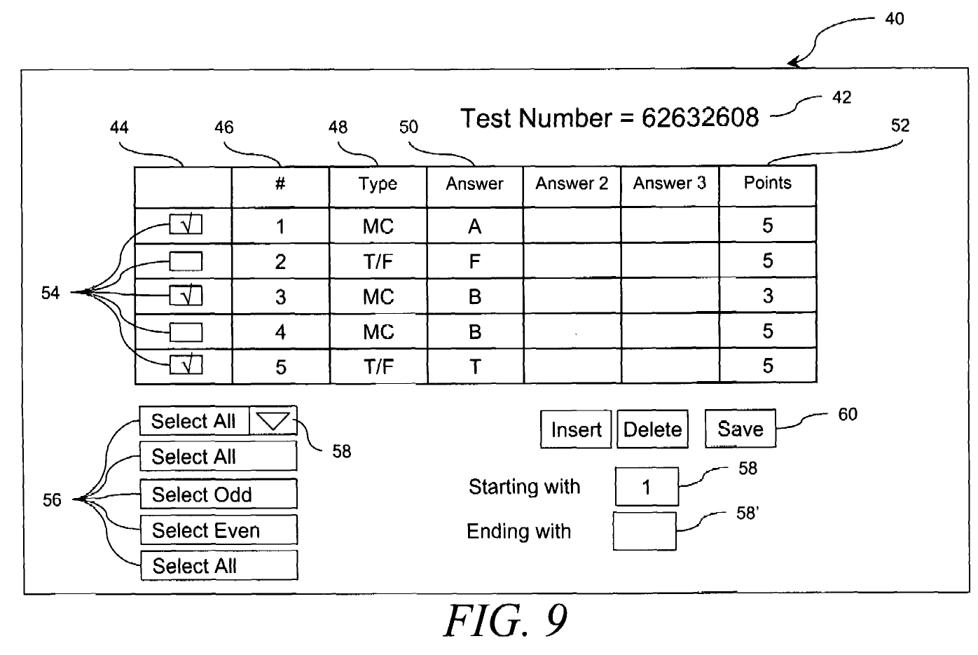

Referring to FIG. 9, in some embodiments of the present invention, it is desirable to provide a user interface having a setup screen 40, displayable on a display device of computer 8, in which a teacher can select which questions are to be associated with a modified question-set that is, for example, a subset of a paper-based question-set, or master question-set. For example, the teacher can use the setup screen 40 to select a master question-set identifier 42. In the illustrated example in FIG. 9, the master question-set has five (5) questions, as represented by question indicia shown in column 46. Three of the questions in the master question-set are multiple choice (“MC”) questions and two are true/false (“T/F”) questions, as shown in column 48. The teacher can produce data to be used for administering a modified question-set. This can be done by, for example, clicking on one or more graphical sections, such as boxes 54, provided in column 44 of the setup screen 40, each box associated with particular question indicia representing a question of the master question-set. In the illustrated example in FIG. 9, the teacher is assigning only three questions from the master question-set having five questions, and has selected questions one (1), three (3), and five (5) using the graphical boxes 54 in column 44. Thereafter, the teacher can assign a new modified question-set identifier, which can be displayed in the setup screen 40, and save the modified question-set data, if desirable.

In some embodiments of the present invention, the modified question-set does not require a modified answer key file to be generated, as responses to questions transmitted from the portable unit 4 automatically include information as to which question number to associate the answer with. Thus, the original answer key file for the master questions set is sufficient for the application program 27 to grade the responses. In other embodiments, a separate modified answer key is generated for association with each modified question-set.

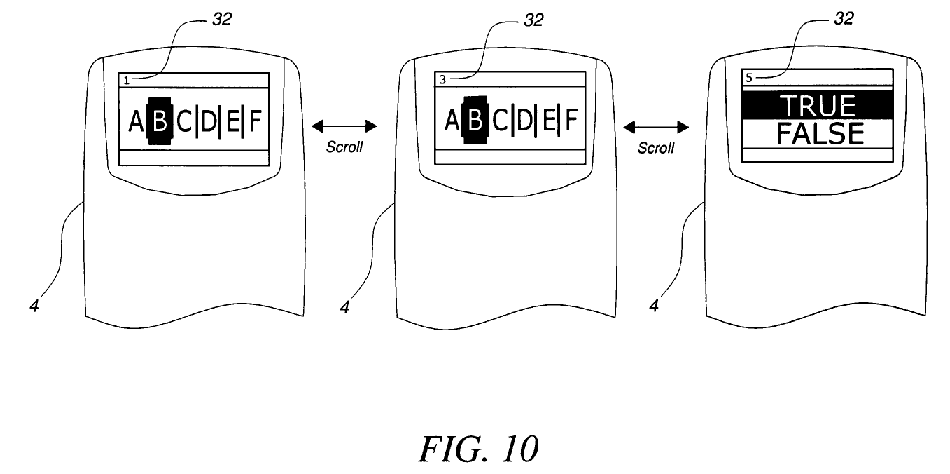

The modified question-set data can be utilized by the application program 27 to transmit instructions to control the portable units 4 such that students can only provide answers to the questions within the modified question-set. Thus, for the example, a portable unit 4, used to respond to questions in the modified question-set illustrated in FIG. 9, can be instructed to allow a student user to only scroll through (e.g., using keys 19 for example to scroll), or select (e.g., pressing a key from alphanumeric keypad 16), question numbers representing questions included in the modified question-set, namely, questions one (1), three (3), or five (5), for the example shown in FIG. 10. FIG. 10 illustrates example user interface settings of the portable unit 4 being displayed as a result of a student scrolling through the question numbers representing the modified question-set of FIG. 9. All other question numbers, and associated user interface settings, can be inaccessible while the user is working on the modified question-set.

As will be appreciated by those skilled in the art after reviewing this disclosure, providing instructions to any one or more portable units 4 to operate in accordance with a particular modified question-set only, can be executed by, for example, a teacher providing a particular modified question-set identifier to computer 8, after which a corresponding instruction can be transmitted to one or more portable units 4 via host 6. The application program 27 can also be used to select a particular portable unit 4, group of portable units, or all portable units on a network (e.g., the entire classroom), to operate in accordance with a particular modified question-set. Furthermore, in some embodiments of the present invention, the application program 27 can be used in a setting that allows students to transmit an identifier corresponding to particular modified question-sets, so that they can operate their particular portable unit 4 in accordance with a particular modified question-set.

Also, it is noted that in some embodiments of the present invention, the student will not need to be informed ahead of time which questions to answer from a paper-based document, since the portable unit 4 can automatically guide the student when operating in accordance with a modified question-set, thereby displaying question indicia (e.g., letters, numbers, titles) corresponding only to those paper-based questions that are to be answered.

Referring again to FIG. 9, in some embodiments, a teacher is provided with a plurality of additional function shortcuts for efficiently modifying a question-set within a setup screen 40. A graphical section, such as a tab 58, can be provided which can be used to pull down a menu of selectable options 56. The selectable options 56 can include “Select All,” to select all questions within a master question-set, “Select Odd” to select only odd questions within the question-set, and “Select Even,” to select only even questions within a question-set. Furthermore, even after one of the selectable options 56 is chosen, the teacher can further adjust the modified question-set by selecting or deselecting the boxes 54 associated with any number of particular questions. In addition, the teacher can select which question the modified question-set will start with using field 58, or end with using field 58′. In some answer key files, or other associated files, points may be pre-associated with questions in a question-set, with the points being used to calculate a point total for determining a student grade for a particular question-set. To provide flexibility for a teacher when selecting data for a modified question-set, the points associated with any particular question in a modified question-set can also be adjusted or selected, by manually entering a number of points associated with the question in column 52.

Audience response systems are commonly used to play educational games, as will be appreciated by those skilled in the art. Another embodiment of the present invention involves the utilization of preprinted paper-based questions in association with games. A teacher can use a setup screen 40 to create data for a modified question-set based on a master question-set from a document. The teacher can then associate a particular interactive graphical presentation with the data for the modified question-set. The graphical presentation can be displayable on a common display, such as, for example, without limitation, a projection system which projects an image of the monitor from computer 8 onto a screen.

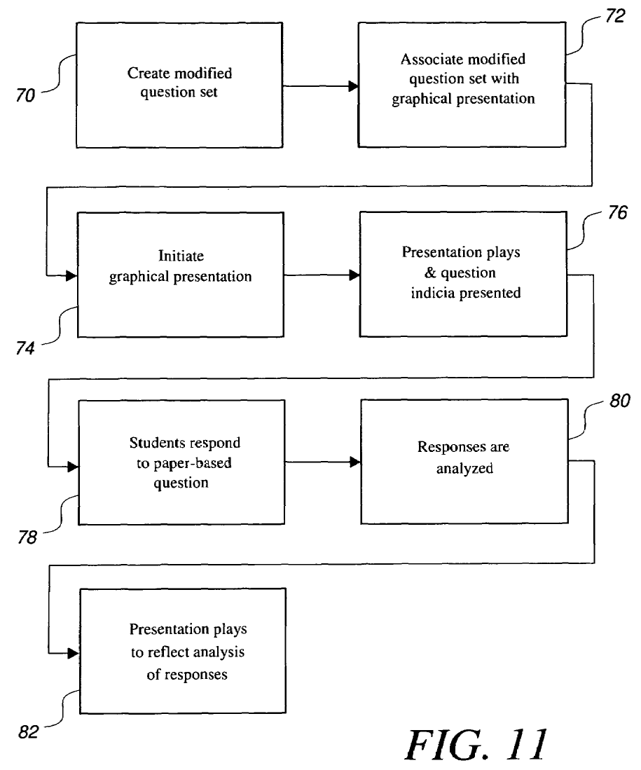

In some example embodiments of the present invention, the graphical presentation is an audiovisual presentation. An audience is comprised of teams of students in a classroom to which a teacher wants to present the modified question-set as a team played game, in which the scores of the teams are compared. The graphical presentation comprises sound and graphics representing racing cars that race around a track and travel a particular distance in proportion to the current score of a team. Referring to FIG. 11, the teacher can create data associated with a modified question-set in step 70 using the setup screen 40. The teacher then uses an application program 27 to associate the modified question-set data with a graphical presentation (such as the racing car example described above), at step 72. The students are asked to refer to a particular pre-existing paper based question-set (e.g., a question-set in a chapter of their text book) and the graphical presentation is then initiated at step 74 (e.g., a visual representation of racing cars associated with each team, positioned at a staring line). A first question in the modified question-set is then indicated, such as, for example, by question number (e.g., the common displays instructs students to answer question number three (3) of their text book), at step 76. The students then refer to their paper-based documents to read the question associated with the question number displayed on the common display, and respond to the question, at step 78. The students do not need to scroll or select question numbers, as the portable units 4 are acting in accordance with the modified question-set associated with the graphical presentation. In some embodiments of the games of the present invention, an instruction to display a particular question number and a particular user interface setting is transmitted to the portable units 4 for each question displayed on the common display, the portable units 4 thereby being synchronized with the graphical presentation so that students, or users, do not have to select any question using the portable units 4, but instead, just respond to the question within the user interface setting presented to them currently. This can be done in some games because the students are not working independently, at their own pace. At step 80, the responses of each student are analyzed (which can include adding all scores of students associated with a particular team). At step 82, the graphical presentation can reflect the points earned by each team, such as by, for example, advancing the graphically represented race cars for each team a distance proportional to the total scores for the corresponding team.

As will be appreciated by those skilled in the art after reviewing this disclosure, in some time-sensitive games, the time it takes for students to scroll through, or select particular question numbers in the portable units while playing the game is cumbersome. Various embodiments of the present invention alleviate this problem.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. An audience response system comprising:
a plurality of portable units for transmitting responses to inquiries, each portable unit having a display device;
a host unit for receiving the responses to the inquiries transmitted by the plurality of portable units; and
a processor usable to analyze the responses received and to compare the responses against answer key data stored on a memory device, the processor further being usable to instruct the plurality of portable units to operate in accordance with a modified question-set.

2. The audience response system of claim 1 wherein when the portable units operate in accordance with the modified question-set, only user interface settings associated with answer choices of the modified question-set may be displayed on the portable units.

3. The audience response system of claim 1 further comprising a display device operable for use in selecting questions from the master question-set to be included in the modified question-set.

4. The audience response system of claim 2 wherein the display device is operable to display indicia representing each question of the master question-set and a plurality of graphical sections with each of the graphical sections being associated with a particular question of the master question-set, and wherein a user can select any one of the plurality of graphical sections to include the associated particular question as part of the modified question-set.

5. The audience response system of claim 1 further comprising a display device operable to display a graphical selection menu, the graphical selection menu being operable to select a group of the plurality of questions from the master question-set.

6. The audience response system of claim 5 wherein the group comprises all odd questions in a sequence of questions of the master question-set or all even questions in a sequence of questions of the master question-set.

7. The audience response system of claim 1 further comprising a display device operable to display a graphical section for use in selecting a starting question number from a master question-set to use as part of a modified question-set.

8. The audience response system of claim 1 further comprising a display device operable to display a graphical section for use in selecting an ending question number to isolate a portion of a master question-set from being included in a modified question-set.

9. The audience response system of claim 1 further comprising a display device operable to display a graphical field for modifying points associated with questions in a modified question-set.

10. A graphical user interface for use in designating a modified question-set based on a master question-set, the graphical user interface comprising:
a plurality of portions capable of displaying a plurality of question indicia representing questions in the master question-set; and
at least one graphical section operable for use in selecting one or more of the plurality of questions from the master question-set to be included in the modified question-set, and wherein there are a plurality of portable units capable of automatically operating in accordance with the modified question-set to be capable of displaying only user interface settings associated with the selected questions and wherein the user interface settings comprise question indicia corresponding to questions of the master question-set.

11. The graphical user interface of claim 10 wherein the modified question-set is associated with a unique identifier and a user can provide the unique identifier to a processor to cause the graphical user interface to display a plurality of indicia representing questions corresponding to the master question-set and to display a plurality of graphical sections that mark particular questions of the master question-set that are included in the modified question-set.

12. The graphical user interface of claim 11 wherein the plurality of graphical sections that mark the questions are each operable for use in deselecting a question to exclude it from the modified question-set.

13. The graphical user interface of claim 10 wherein the at least one graphical section includes a graphical menu for selecting different subsets of questions from the master question-set.

14. The graphical user interface of claim 13 wherein at least one of the different subsets of questions corresponds to odd questions in a sequence of questions or even questions in a sequence of questions.

15. The graphical user interface of claim 10 wherein the master question-set is sequentially ordered, and wherein the at least one graphical section is a field for designating a question from the sequentially ordered master question-set that will serve as a first question in a modified question set.

16. The graphical user interface of claim 10 wherein the master question-set is sequentially ordered, and wherein the at least one graphical selection is a field for designating a question from the sequentially ordered master question-set that will serve as a last question in the modified question set.

17. The graphical user interface of claim 10 further comprising a graphical section usable to cause the modified question-set to be saved to a memory device.

18. A method of retrieving answers to questions in an audience response system comprising:
providing a plurality of portable units to a plurality of users;
providing paper-based documents to the plurality of users, the paper-based documents containing at least one master question-set;
controlling at least one display device of the plurality of portable units to be capable of displaying only user interface settings associated with a subset of questions of the at least one master question-set; and
receiving responses to questions of the at least one master question-set provided in the paper-based documents, the responses being transmitted from at least one of the plurality of portable units.

19. The method of claim 18 further comprising using a graphical user interface to display a list of question indicia representing the at least one master question-set, and using the graphical user interface for selecting one or more of the questions from the master question-set to define the subset.

20. The method of claim 19 wherein selecting one or more of the questions comprises displaying graphical sections associated with each of the question indicia, and selecting the graphical sections using a pointer device.

21. The method of claim 19 wherein selecting one or more of the questions comprises displaying selectable options for selecting all odd questions in a sequence or all even questions in a sequence associated with the master question-set.

22. The method of claim 21 further comprising selecting a starting question from the at least one master question-set, with all questions coming sequentially before the starting questions being isolated from the subset.

23. The method of claim 21 further comprising selecting an ending question from the at least one master question-set, with all questions coming sequentially after the ending question being isolated from the subset.

24. The method of claim 19 further comprising saving the subset in a memory device and associating a modified question-set identifier with the subset for use in recalling the subset.

25. The method of claim 18 further comprising providing as input to a processor, a modified question-set identifier associated with the subset of questions prior to controlling the at least one display device.

26. The method of claim 18 wherein controlling the at least one display device comprises transmitting a modified question-set identifier from at least one of the plurality of portable units to a host unit, the modified question-set identifier being associated with the subset.

27. A computer implemented method of playing a game comprising:
creating a modified question-set based on a master question-set of a paper-based document and storing data for the modified question-set on a memory device;
associating the data for the modified question-set with a graphical presentation;
initiating the graphical presentation;
presenting a graphical question identifier to identify a particular question of the master question-set that is included in the modified question-set, the graphical question identifier being usable to locate a question on the paper-based document;
receiving a plurality of responses to the particular question;
analyzing the responses; and
displaying a change in the graphical presentation to reflect a result derived from analyzing the responses.

28. A computer readable medium having instructions stored thereon for instructing a computer to carry out a method comprising:
displaying a graphical user interface listing a plurality of question indicia associated with a master question-set, the questions of the master question-set being provided on a paper-based document;
receiving instructions for selecting one or more questions of the master question-set to be included in a modified question-set; and
sending an instruction to a plurality of remote devices to allow the remote devices to be operable in accordance with the modified question-set.

29. The computer readable medium of claim 28 wherein when the remote devices operate in accordance with the modified question-set, they are operable to request responses to only a subset of questions from the master question-set by displaying question indicia corresponding to the selected questions from the master question-set.

30. The computer readable medium of claim 28 wherein the method further comprises displaying on the graphical user interface, graphical sections associated with each of the question indicia, and receiving a selection of the graphical sections using a pointer device to designate questions as part of the modified question-set.

31. The computer readable medium of claim 28 wherein the method further comprises displaying on the graphical user interface, selectable options for selecting all odd questions in a sequence of questions or all even questions in a sequence questions.

32. The computer readable medium of claim 28 wherein the method further comprises allowing a user to select a starting question from the master question-set such that all questions prior to the starting question are excluded from the modified question-set.

33. The computer readable medium of claim 28 wherein the method further comprises allowing a user to select an ending question from the master question-set such that all questions after the ending question are excluded from the modified question-set.

34. The computer readable medium of claim 28 wherein the method further comprises saving the data for defining the modified question-set on a memory device and associating the data with a modified question-set identifier.

35. The computer readable medium of claim 34 wherein the method further comprises receiving the modified question-set identifier and causing a graphical user interface to be displayed listing the plurality of question indicia associated with a master question-set and further displaying a plurality of graphical sections that mark various ones of the question indicia representing those questions that are included in the modified question set.
